(19) United States
(12) Patent Application Publication
(10) Pub. No.: US 2019/0240972 A1
(43) Pub. Date: Aug. 8, 2019

(54) DOCTOR BLADE AND PRINTING APPARATUS

(71) Applicant: SHARP KABUSHIKI KAISHA, Sakai City (JP)

(72) Inventor: SHINYA TANAKA, Sakai City (JP)

(21) Appl. No.: 16/262,330

(22) Filed: Jan. 30, 2019

(30) Foreign Application Priority Data
Feb. 2, 2018 (JP) 2018-017143

(51) Int. Cl. B41F 35/00; B41F 5/24

(52) U.S. Cl. CPC B41F 35/008; B41F 5/24

(57) ABSTRACT

A doctor blade for spreading a coating solution supplied to a roll surface of an anilox roll rotatable about a rotation axis over the roll surface is in a longitudinal plate shape. The doctor blade includes a long edge and bent portions. The long edge is set against the roll surface of the anilox roll along the rotation axis. The bent portions are at ends of the long edge and at angles to the long edge.

### CROSS REFERENCE TO RELATED APPLICATION

This application claims priority from Japanese Patent Application No. 2018-017143 filed on Feb. 2, 2018. The entire contents of the priority application are incorporated herein by reference.

### TECHNICAL FIELD

The technology described herein relates to a doctor blade and a printing apparatus equipped with the doctor blade.

### BACKGROUND

As an example of printing apparatuses, a flexo printing apparatus is known in which a flexible relief plate that is flexible and elastic, such as a resin or rubber plate is used with a water-based resin solution or ultraviolet resin solution as a coating solution. In the flexo printing apparatus, an anilox roll (an engraved roll) having a roll surface finely engraved is used to transfer a coating solution held on the roll surface of the anilox roll in a uniform thickness is transferred to the flexible relief plate. In producing a liquid crystal display device, for example, such a flexo printing apparatus is used to form a protective film (an insulating film) on electrodes or wires formed on a first motherboard, or to form an alignment film that aligns liquid crystal molecules in the uppermost layer.

Japanese Unexamined Patent Application Publication No. 2007-69382 discloses an example of such a printing apparatus that suppresses printing unevenness equipped with solution spreading units configured to spread, over the roll surface, a resin solution (a coating solution) supplied on the roll surface of an anilox roll.

For the solution spreading unit of the printing apparatus, a doctor blade is typically used. The doctor blade has a blade edge that contacts the roll surface of the anilox roll. The blade is rockably mounted on the printing apparatus, and the blade scrapes an excess of a coating solution dropped onto the roll surface of the anilox roll with the blade edge. Thus, the blade spreads the coating solution in a uniform thickness over the roll surface. However, when the scraped excess coating solution is attached to the roll surface on the downstream side of the contact position with the doctor blade in the rotation direction of the anilox roll, the thickness of the coating solution to be transferred to the flexible relief plate becomes uneven, sometimes resulting in printing unevenness. Therefore, for example, in the case in which the doctor blade is applied to forming the alignment film of a liquid crystal display device, the uniformity of the alignment film is impaired, and the alignment of the liquid crystal molecules is disturbed, causing display quality degradation.

### SUMMARY

The technology described herein was made in view of the above circumstances. An object is to suppress printing unevenness in a flexo printing apparatus.

A doctor blade according to the technology described herein is for spreading a coating solution supplied to a roll surface of an anilox roll rotatable about a rotation axis over the roll surface. The doctor blade is in a longitudinal plate shape. The doctor blade includes a long edge and bent portions. The long edge is set against the roll surface of the anilox roll along the rotation axis. The bent portions are at ends of the long edge and at angles to the long edge.

With the bent portions, an excess of the coating solution scraped from the roll surface of the anilox roll by the one long edge is less likely to spread to the ends of the doctor blade or the back of the doctor blade. Note that in order to effectively reduce the leakage of the excess coating solution to the back of the doctor blade, the long edge of the doctor blade is desirably formed longer than the contact part of the anilox roll.

A printing apparatus according to the technology described herein is a printing apparatus including: an anilox roll rotatable about a rotation axis; a supply unit configured to supply a coating solution to the roll surface of the anilox roll; a doctor blade configured to spread the coating solution supplied to the roll surface of the anilox roll over the roll surface; and a transfer unit configured to transfer the coating solution spread over the roll surface of the anilox roll to a print subject. The doctor blade is in a longitudinal plate shape. The doctor blade includes a long edge mounted such that the long edge contacts the roll surface of the anilox roll along the rotation axis, and bent portions at ends of the long edge and at angles to the long edge.

In the printing apparatus having the configuration, the doctor blade includes the bent portions. Therefore, an excess of the coating solution is less likely to spread to the ends of the doctor blade or 1 the back of the doctor blade. According to the configuration, printing unevenness due to the excess of the coating solution on the roll surface of the anilox roll on the downstream side of the contact position with the doctor blade is less likely to occur.

With the use of the printing apparatus equipped with the doctor blade according to the technology described herein, printing unevenness is reduced. For example, a display panel excellent in display quality and reliability can be obtained because an alignment film or an insulating film is uniformly formed on a substrate.

### BRIEF DESCRIPTION OF THE DRAWINGS

FIG. 1 is a schematic diagram of the schematic configuration of a printing apparatus.

FIG. 2A is a plan view of a doctor blade.

FIG. 2B is a front view of the doctor blade.

FIG. 3 is an enlarged perspective view of main components illustrating the end part shape of the doctor blade held on a doctor blade holder.

FIG. 4 is a schematic diagram of the contact part between the doctor blade and an anilox roll viewed from the upstream side of the anilox roll.

FIG. 5 is a schematic diagram of the contact part in FIG. 4 viewed from the downstream lateral side of the anilox roll.

FIG. 6 is a schematic diagram of the contact part between a doctor blade and an anilox roll viewed from the upstream side of the anilox roll according to a conventional art.

FIG. 7 is a schematic diagram of the contact part in FIG. 6 viewed from the downstream lateral side of the anilox roll.

### DETAILED DESCRIPTION

### First Embodiment

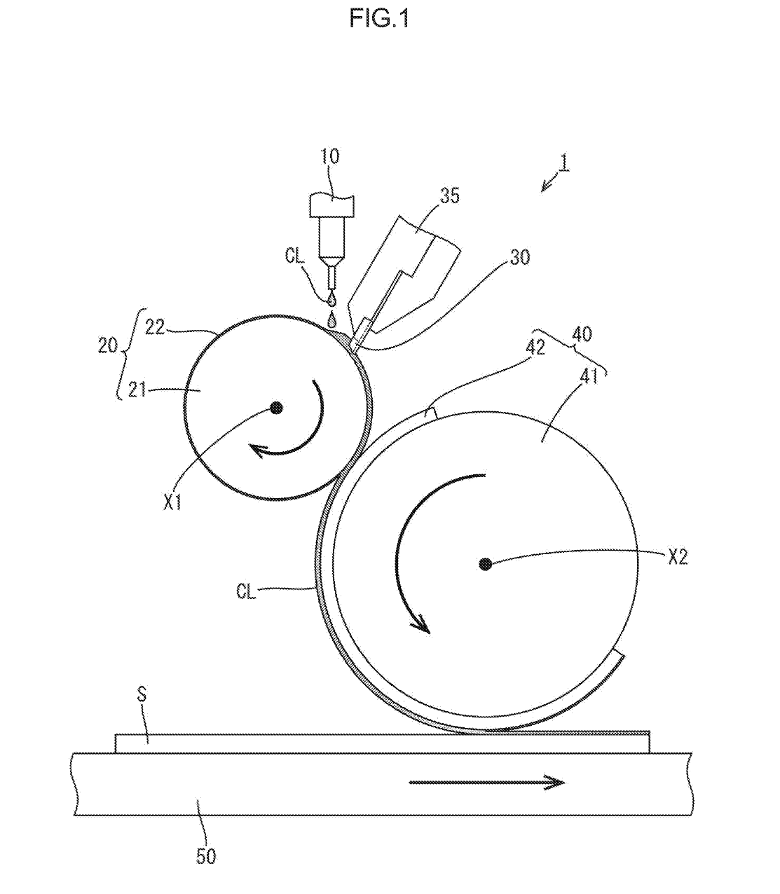

A first embodiment will be described will be described with reference to FIGS. 1 to 5.

In the first embodiment, the flexo printing apparatus (an example of a printing apparatus) 1 will be described as an example. Note that one of the same members is designated with a reference sign, and reference signs are sometimes omitted on the remaining members.

The flexo printing apparatus 1 according to the first embodiment can be used for printing (coating) a substrate S with an alignment film forming resin including a polyimide resin, for example, in forming an alignment film on the substrate S constituting a liquid crystal panel (a display panel), for example. Alternatively, the flexo printing apparatus 1 may be used for printing a substrate S with a coating solution including and insulating resin, for example, in forming an insulating film on the substrate S.

As schematically as illustrated in FIG. 1, the flexo printing apparatus 1 includes a dispenser (an example of s supply unit) 10, an anilox roll 20, a doctor blade 30, a printing cylinder (an example of a transfer unit) 40 to which a flexible relief plate 42 is fixed, and a stage 50.

The dispenser 10 discharges a coating solution CL, and supplies the coating solution CL to the roll surface of the anilox roll 20. The dispenser 10 may be configured in which the dispenser 10 is connected to a pressure device and discharges the coating solution CL held the inside of the dispenser 10 at a constant pressure. The dispenser 10 may be configured in which the dispenser 10 is mounted such that the dispenser 10 reciprocatingly moves along a rotation axis X1 of the anilox roll 20 (reciprocating motion between the front side and the back side on FIG. 1) and the dispenser 10 drops the coating solution CL onto the roll surface while moving over the roll surface of the anilox roll 20.

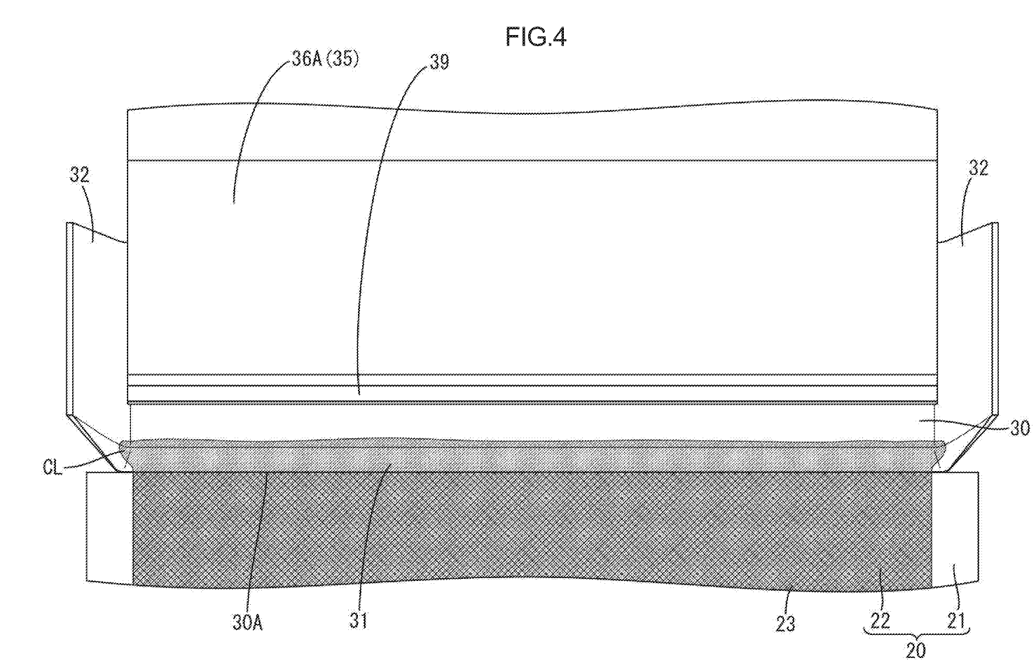

The anilox roll 20 is cylindrical in shape, and rotatably mounted about the rotation axis X1 in the flexo printing apparatus 1. In the first embodiment, in the case in which the flexo printing apparatus 1 is viewed from the direction as illustrated in FIG. 1, the anilox roll 20 rotates clockwise. The anilox roll 20 has a structure in which most of the roll surface of a metal roll main body 21 is covered with ceramic plating 22 except both ends of the roll main body 21 in the direction of the rotation axis X1 (e.g. see FIG. 4). The roll main body 21 may be covered with chromium plating instead of the ceramic plating 22. On the surface of the ceramic plating 22, cells 23 that are a large number of micro recesses are uniformly and entirely formed. The coating solution CL supplied from the dispenser 10 can be held in the cells 23 (see FIG. 4 and other drawings). Note that the number of anilox lines per unit area configuring the cell 23 is set suitable for purposes. However, typically, the capacity of the cell 23 is decreased as the number of lines is increased, and the amount of the coating solution CL to be transferred to the flexible relief plate 42 is decreased. The shape of the cell can be set suitable for purposes, such as a honeycomb pattern, a diamond pattern, and a groove helical pattern. In the first embodiment, the cell 23 in a diamond pattern is described as an example.

The printing cylinder 40 is cylindrical in shape having a diameter larger than the diameter of the anilox roll 20. The printing cylinder 40 is rotatably mounted about a rotation axis X2 in the flexo printing apparatus 1. The printing cylinder 40 is mounted such that the rotation axis X2 is in parallel with the rotation axis X1 of the anilox roll 20, and the printing cylinder 40 is rotated in the opposite direction to the anilox roll 20. That is, the first embodiment in FIG. 1, the printing cylinder 40 is rotated counterclockwise. The printing cylinder 40 has a structure in which the flexible relief plate 42 is closely fixed to a part of the roll surface of a metal roll main body 41 in the circumferential direction. The anilox roll 20 and the printing cylinder 40 are mounted such that when the roll 20 and the printing cylinder 40 are rotated, the surface of the flexible relief plate 42 is pressed against the roll surface of the anilox roll 20 as rotated, and hence the coating solution CL held on the roll surface of the anilox roll 20 is transferred to the flexible relief plate 42. The flexible relief plate 42 is formed of a resin, for example. The flexible relief plate 42 has a surface on which a large number of micro grooves are formed suitable for the print pattern of the coating solution CL, and the coating solution CL transferred from the anilox roll 20 can be held on the surface.

On the stage 50, the substrate S that is a print subject is placed. The stage 50 can be translated in the flexo printing apparatus 1. The stage 50 moves the substrate S placed on the stage 50, and brings the substrate S in intimate contact with the surface of the flexible relief plate 42 with the coating solution CL held on the downstream side of the contact position with the anilox roll 20 in the rotation direction of the printing cylinder 40. Thus, the coating solution CL held on the flexible relief plate 42 is transferred to the substrate S and printed on the substrate S. The stage 50 may be configured such that the stage 50 is translated in synchronization with the rotation of the printing cylinder 40, for example. The stage 50 may be configured, for example, in which a large number of suction holes connected to a vacuum tube are provided on the surface and the substrate S placed on the surface is fixed. The substrate S can be an array substrate or a counter substrate constituting a liquid crystal panel, for example.

The coating solution CL dropped from the dispenser 10 onto the roll surface of the anilox roll 20 is spread by the doctor blade 30 that is a solution spreading unit.

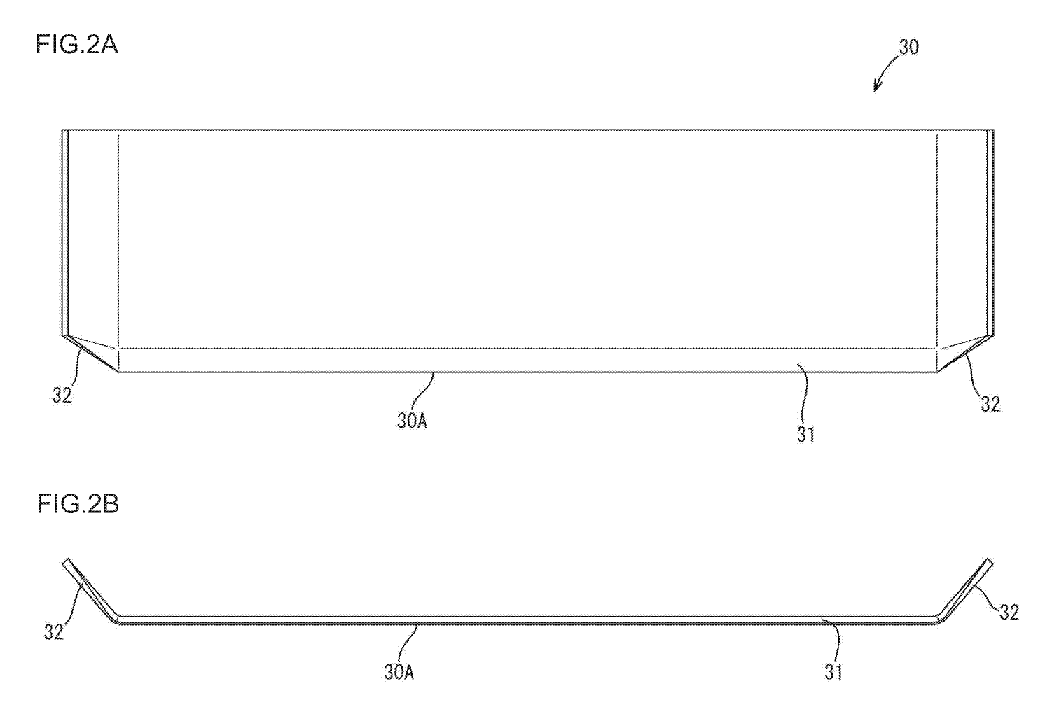

As illustrated in FIGS. 2A and 2B, the doctor blade 30 according to the first embodiment is formed of a longitudinal steel plate, and a blade edge 31 is formed on a primary edge 30A. In the flexo printing apparatus 1, the doctor blade 30 is mounted such that the blade edge 31 is rockable and contacts the roll surface of the anilox roll 20 along the rotation axis X1. When the anilox roll 20 is rotated, the blade edge 31 of the doctor blade 30 contacts the surface of the ceramic plating 22 provided on the roll surface, and the doctor blade 30 spreads the coating solution CL dropped from the dispenser 10 onto the entire surface of the ceramic plating 22 on the upstream side of the contact position, and then all the cells 23 are uniformly filled with the coating solution CL. The blade edge 31 scrapes the excess coating solution CL flowing out of the cells 23, and hence the thickness of the coating solution CL held on the roll surface of the anilox roll 20 is made uniform. In the first embodiment, the doctor blade 30 having the blade edge 31 formed in a tapered shape thinner toward the long edge 30A is described as an example. In the doctor blade 30 according to the first embodiment, a bent portion 32 is formed at the both ends of the blade edge 31. The bent portion 32 will be described later.

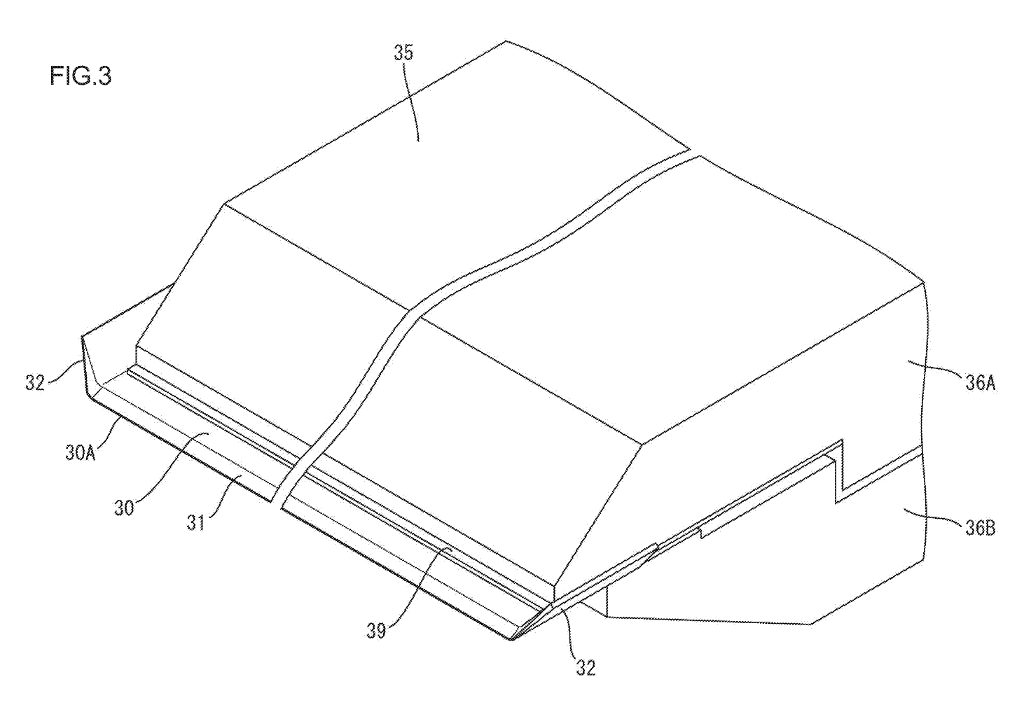

As illustrated in FIG. 3 and other drawings, the doctor blade 30 is held by a doctor blade holder 35, for example. The doctor blade holder 35 has holder members 36A and 36B of high stiffness that are two separate parts and bolts disposed at equal intervals. The bolts are tightened with the doctor blade 30 sandwiched between the holder members 36A and 36B, and hence the doctor blade 30 is fixed and held on the doctor blade holder 35. Rotatably disposing the doctor blade holder 35 in the flexo printing apparatus 1, for example, enables mounting the doctor blade 30 in the rockable state. The doctor blade 30 according to the first embodiment is mounted such that the tapered part of the blade edge 31 is directed to the upstream side of the anilox roll 20. In order to control the flexibility of the blade edge 31, the projection length (the projection length of the blade edge) of the doctor blade 30 from the tip end of the doctor blade holder 35 or the contact angle of the blade edge 31 to the anilox roll 20 is adjusted when the doctor blade 30 is mounted on the doctor blade holder 35. Alternatively, a backup blade 39 may be laid over the doctor blade 30 and sandwiched between the holder members 36A and 36B. The backup blade 39 is a blade that avoids problems in scraping of the excess coating solution CL due to excess flexibility of the doctor blade 30 made of a thin plate. The backup blade 39 is held on the doctor blade holder 35 together with the doctor blade 30 to stabilize the scraping effect with laid on one face or both faces of the doctor blade 30. As illustrated in FIG. 3 and other drawings, in the first embodiment, the case in which one backup blade 39 is laid on the upstream side (the tapered side) of the doctor blade 30 is described as an example.

Referring to FIG. 1, the main operation of the flexo printing apparatus 1 having the schematic configuration described above will be briefly described supposing that an alignment film forming resin is printed on the substrate S.

First, the dispenser 10 is filled with the coating solution CL including an alignment film forming resin, such as a polyimide resin, and adjusted to have an appropriate viscosity. The anilox roll 20 is rotated, and the coating solution CL is dropped onto the ceramic plating 22 configuring the roll surface of the anilox roll 20, while the dispenser 10 is reciprocated along the rotation axis X1. The coating solution CL dropped onto the ceramic plating 22 is spread over the entire surface with the doctor blade 30 that contacts the surface on the downstream side of the contact position, and uniformly charged in the cell 23. The excess coating solution CL flowing out of the cells 23 is scraped by the blade edge 31 of the doctor blade 30. Thus, the coating solution CL is spread and held almost in a uniform thickness on the roll surface of the anilox roll 20.

Subsequently, the printing cylinder 40 to which the flexible relief plate 42 is fixed is rotated while the rotation of the anilox roll 20 is maintained, and the roll surface of the anilox roll 20 is pressed against the flexible relief plate 42 as rotated. Thus, the coating solution CL held in the cells 23 of the anilox roll 20 is transferred and held on the flexible relief plate 42.

Subsequently, the stage 50 is translated in synchronization with the rotation of the printing cylinder 40, and the substrate S is supplied below the printing cylinder 40. For example, an adjustment is provided in which when the upstream end part of the flexible relief plate 42 is reached at the undermost part on the downstream side of the contact position with the anilox roll 20 in the rotation direction of the printing cylinder 40, the upstream end part contacts the front end part of the substrate S in the traveling direction, and the flexible relief plate 42 and the substrate S are moved at the same velocity. Thus, the coating solution CL held on the flexible relief plate 42 is transferred and printed on the substrate S and printed on the substrate S.

Here, in the flexo printing apparatus 1 according to the first embodiment as described above, the configuration that suppresses printing unevenness will be described in detail.

As such a configuration, in the doctor blade 30 according to the first embodiment as illustrated in FIG. 3 and other drawings, the both end parts of the blade edge 31 formed on the long edge 30A are extended and bent to form the bent portions 32.

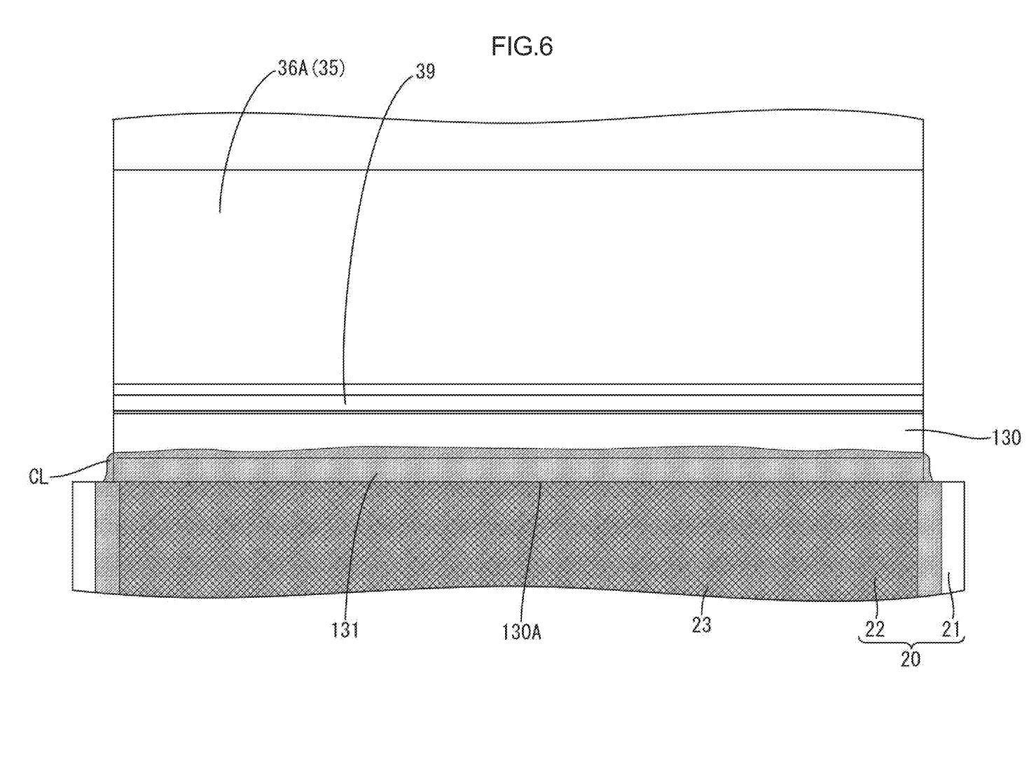

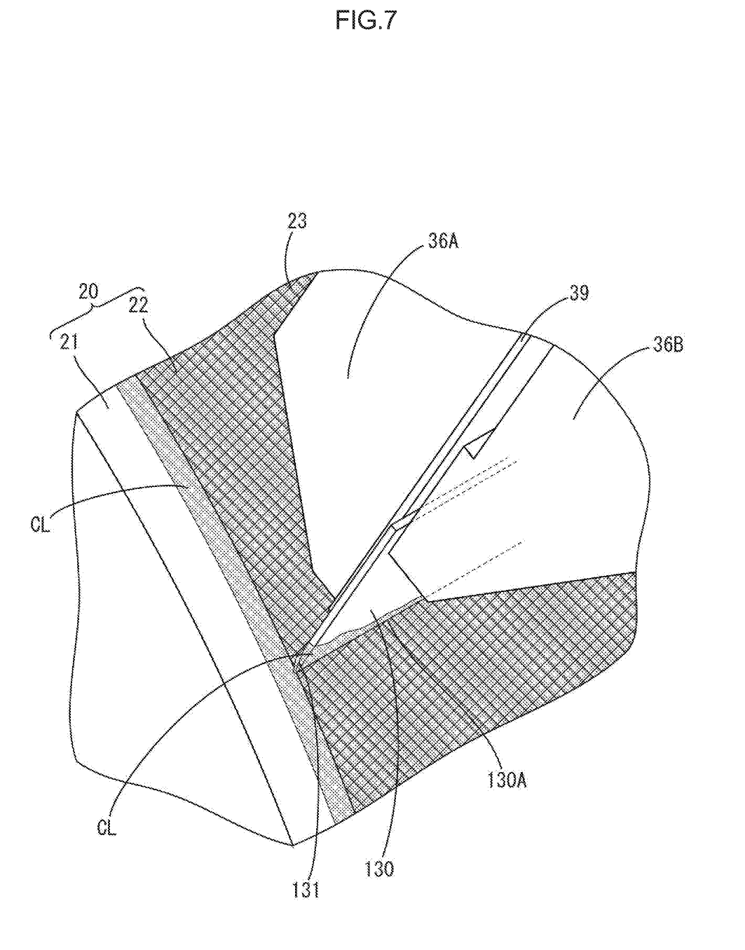

Referring to FIGS. 6 and 7, in order to clarify the operation and effect by forming the bent portions 32, first, the case in which a doctor blade 130 in a conventional structure having no bent portion 32 is used to spread a coating solution CL dropped onto an anilox roll 20 will be described. Note that in the following, in the description of a conventional art, configurations similar to the first embodiment are designated with the same reference signs, and the description is omitted.

The doctor blade 130 has a blade edge 131 that contacts the surface of a ceramic plating 22 of an anilox roll 20, and is formed in a flat, longitudinal plate shape overall. The blade edge 131 is provided along the entire length of a long edge 130A of the doctor blade 130. The length is almost equivalent to the width of the ceramic plating 22 of the anilox roll 20.

In the case in which the doctor blade 130 in this form is used, as illustrated in FIG. 6, an excess coating solution CL flowing out of the cell 23 and scraped by the blade edge 131 is spread on the both ends where a roll main body 21 is exposed on the anilox roll 20, and the coating solution CL resides on the front side (the upstream side) of the blade edge 131. As illustrated in FIG. 7, the residing coating solution CL is soon leaked from the both ends of the flat blade edge 131 of the doctor blade 130 around the back side (the downstream side), and attached to the surface of the ceramic plating 22 on the downstream side of the doctor blade 130. The coating solution CL that is spread in a uniform thickness by the doctor blade 130 and then attached to the anilox roll 20 is transferred to a flexible relief plate 42 as it is. Thus, the thickness of the coating solution CL to be transferred to the flexible relief plate becomes uneven. More specifically, with an increase in the amount of the excess coating solution CL in association with an increase in the number of sheets of printing, the amount of the coating solution CL that resides at the both ends of the doctor blade 130 and is leaked around the back side is increased, and the excess coating solution CL goes to the center of the blade edge 131 in the longitudinal direction. Thus, printing unevenness sometimes reaches near the center of the print pattern. In the case in which such an apparatus is applied to forming the alignment film on a liquid crystal panel substrate, for example, the occurrence of printing unevenness in the display region of the liquid crystal panel impairs the uniformity of the alignment film, and the alignment of the liquid crystal molecules is disturbed, causing display quality degradation.

Unlike the doctor blade 130 in the conventional structure, the doctor blade 30 according to the first embodiment has the bent portions 32 as illustrated in FIGS. 2A, 2B, and 4 and any other drawing. The long edge 30A of the doctor blade 30 is formed longer than the long edge 130A of the doctor blade 130. The end parts located on both sides of the blade edge 31 of the long edge 30A are bent to the side where the tapered part is provided on the blade edge 31 (on the front side, i.e. the side directed to the upstream side of the anilox roll 20 in the flexo printing apparatus 1), and the bent portions 32 are formed. The width or the bent angle of the bent portions 32 is non-limiting specifically. Preferably, the width or the bent angle is appropriately adjusted such that the doctor blade 30 is mounted at an angle suitable for scraping the coating solution CL on the ceramic plating 22 with no problem and the scraped excess coating solution CL can be held on the front side of the blade edge 31 sandwiched between the bent portions 32, described later. In the doctor blade 30 described as an example in the first embodiment, the both ends of the blade edge 31 in length almost equivalent to the width of the ceramic plating 22 are extended by the length of approximately from 2 to 5 times the tapered width of the blade edge 31. The extended part is erected at an angle of approximately 45 degrees toward the tapered side of the blade edge 31, and then the bent portion 32 is formed. The corner of the bent portion 32 on the long edge 30A side is obliquely cut so as not to interfere with the roll surface of the anilox roll 20.

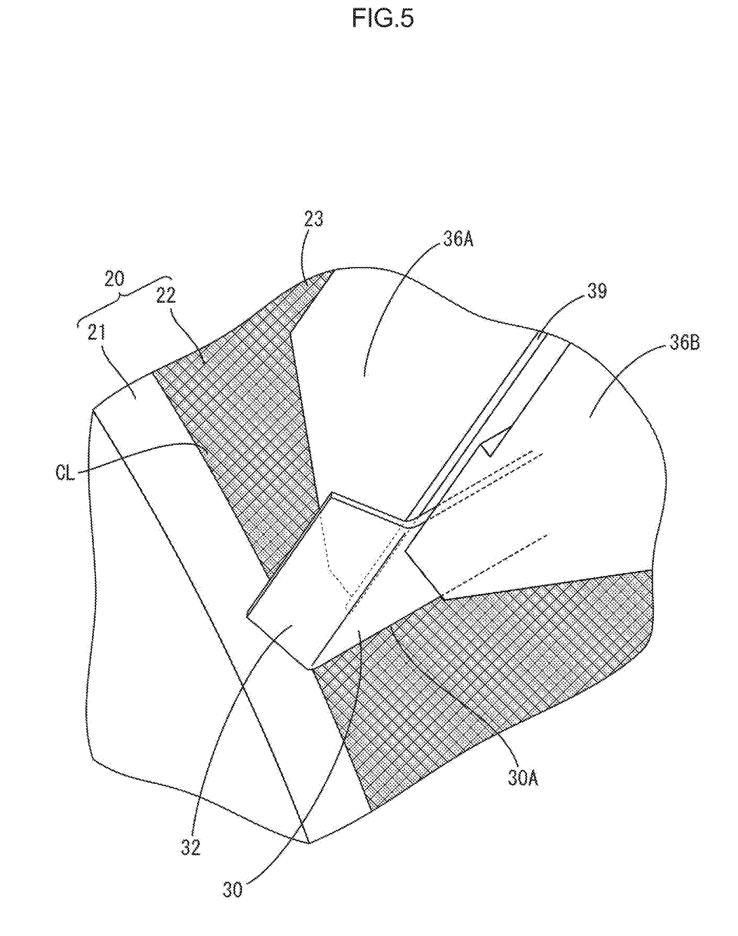

Referring to FIGS. 4 and 5, the case in which the coating solution CL dropped onto the anilox roll 20 is spread using the doctor blade 30 according to the first embodiment will be described.

As illustrated in FIG. 4, the excess coating solution CL flowing out of the cell 23 and scraped by the blade edge 31 resides on the front side (the upstream side) of the blade edge 31 of the doctor blade 30. At this time, the bent portions 32 are formed, and hence this suppresses the spread of the coating solution CL on the both end sides of the anilox roll 20. The bent portions 32 also suppress the event that the coating solution CL that resides on the front side of the blade edge 31 is leaked from the both ends of the blade edge 31 around the back side (the downstream side) of the doctor blade 30. Even in the case in which the amount of the excess coating solution CL is increased in association with an increase in the number of sheets of printing, the coating solution CL in a certain amount can be held in the space formed by the blade edge 31 and the two bent portions 32 on the front side of the doctor blade 30. Thus, the amount of the coating solution CL that is leaked around the back side of the doctor blade 30 is decreased, and hence the amount of the coating solution CL that goes to the center in the longitudinal direction is also decreased.

As described above, the doctor blade 30 according to the first embodiment has the configuration in (1).

(1) The doctor blade 30 is for spreading the coating solution CL supplied to the roll surface of the anilox roll 20 rotatable about the rotation axis X1 over the roll surface. The doctor blade 30 is in a longitudinal plate shape. The doctor blade 30 includes a long edge 30A and bent portions 32. The long edge 30A is set against the roll surface of the anilox roll 20 along the rotation axis X1. The bent portions 32 are at the ends of the long edge 30A and at angled to the long edge 30A.

In the doctor blade in (1), the bent portions 32 are formed, and hence this suppresses the event that the excess coating solution CL scraped from the roll surface of the anilox roll 20 is spread to the both ends the blade edge 31 of the doctor blade 30 in contact with the roll surface and leaked around the back side (the downstream side). Note that in order to effectively suppress only the leak of the excess coating solution CL around the back side, the long edge 30A of the doctor blade 30 is desirably formed such that the length of the long edge 30A is longer than the length of the blade edge 31 that contacts the anilox roll.

The flexo printing apparatus 1 according to the first embodiment has the configurations in (2) to (4).

(2) The flexo printing apparatus 1 includes: the anilox roll 20 rotatable about the rotation axis X1; the dispenser (a supply unit 10 that supplies the coating solution CL to the ceramic plating 22 provided on the roll surface of the anilox roll 20; the doctor blade 30 that spreads the coating solution CL supplied to the ceramic plating 22 of the anilox roll 20 over the surface of the ceramic plating 22; and the printing cylinder (a transfer unit) 40 that transfers the coating solution CL spread over the surface of the ceramic plating 22 of the anilox roll 20 to the substrate (a print subject) S. The doctor blade 30 is in a longitudinal plate shape. The doctor blade 30 includes the long edge 30A and bent portions 32. The long edge 30A is set against the roll surface of the anilox roll 20 along the rotation axis X1. The bent portions 32 are at the ends of the long edge 30A and at angles to the long edge 30A.

In the printing apparatus having the configuration of (2), the doctor blade 30 includes the bent portions 32. With the doctor blade 30, an excess of the coating solution CL is less likely to spread to the ends of the doctor blade 30 or the back of the doctor blade 30. According to the configuration, printing unevenness due to the excess coating solution CL attached to the roll surface of the anilox roll 20 on the downstream side of the doctor blade 30 is less likely to occur.

(3) In the flexo printing apparatus 1 in (2), the bent portions 32 of the doctor blade 30 are angled toward the upstream side in the rotation direction of the anilox roll 20 relative to the plate face of the doctor blade 30.

In the configuration (3), the bent portions 32 of the doctor blade 30 are located on the upstream side in the rotation direction of the anilox roll 20. According to the configuration, a certain amount of the excess of the coating solution CL remains on the front side (the upstream side) of the doctor blade. Thus, the excess of the coating solution CL is less likely to spread to the ends of the doctor blade 30 or the back of the doctor blade 30.

(4) In the flexo printing apparatus 1 in (2) or (3), the coating solution CL is a resin solution including an alignment film forming resin for alignment of the liquid crystal molecules. The substrate S is a component of a display panel.

According to the configuration in (4), printing unevenness in coating an alignment film forming resin or an insulating resin is suppressed. Therefore, the uniformity of the alignment film or the insulating film improves. As a result, problems, such as disturbing the alignment of liquid crystal molecules or the occurrence of short circuits, are decreased, and hence a display panel excellent in display quality and reliability can be obtained.

### Other Embodiments

The technology described herein is not limited to the embodiment described above and with reference to the drawings. The following embodiment may be included in the technical scope.

(1) The material and the shape of the doctor blade are non-limiting to the embodiment described above. The doctor blade is preferably flexible and stiffness. The doctor blade may be made of various metals, such as steel, or may be made of a resin. The blade edge can be formed in various shapes, such as a straight shape with no step, round shape, and beveled shape, in addition to stepped shape or tapered shape such that the blade edge is thin, suitable for purposes.

(2) The bent portion, the shape, and the bent angle of the doctor blade are non-limiting to the embodiment described above. For example, the bent portion may be formed to have a curved surface.

(3) The embodiment is non-limiting to the flexo printing apparatus that prints the substrate of a display panel. The technology described herein is applicable to the case in which various types of coating solutions CL are used to print various print subjects.

1. A doctor blade in a longitudinal plate shape for spreading a coating solution supplied to a roll surface of an anilox roll rotatable about a rotation axis over the roll surface, the doctor blade comprising:
a long edge set against the roll surface of the anilox roll along the rotation axis; and
bent portions at ends of the long edge and at angles to the long edge.

2. A printing apparatus comprising:
an anilox roll rotatable about a rotation axis;
a supply unit configured to supply a coating solution to a roll surface of the anilox roll;
a doctor blade configured to spread the coating solution supplied to the roll surface of the anilox roll over the roll surface; and
a transfer unit configured to transfer the coating solution spread over the roll surface of the anilox roll to a print subject, wherein
the doctor blade is in a longitudinal plate shape, and
the doctor blade includes:
a long edge set against the roll surface of the anilox roll along the rotation axis; and
bent portions at ends of the long edge and at angles to the long edge.

3. The printing apparatus according to claim 2, wherein the bent portions of the doctor blade are angled toward an upstream side in a rotation direction of the anilox roll relative to a plate face of the doctor blade.

4. The printing apparatus according to claim 2, wherein
the coating solution is a resin solution including an alignment film forming resin for alignment of liquid crystal molecules or an insulating resin, and
the print subject is a substrate constituting a display panel.
